(19) United States
(12) Patent Application Publication
(10) Pub. No.: US 2016/0300159 A1
(43) Pub. Date: Oct. 13, 2016

(54) System and Method of Specialized Identification Card Access to Multiple Cloud-Based Vendor Offerings

(71) Applicant: Patrick Steinmayr, Snowmass Village, CO (US)

(72) Inventor: Patrick Steinmayr, Snowmass Village, CO (US)

(21) Appl. No.: 14/681,736

(22) Filed: Apr. 8, 2015

(51) Int. Cl. G06Q 10/02; G06Q 50/00; G06Q 20/40; G06F 17/30; G06Q 20/18; G06Q 20/20

(52) U.S. Cl. CPC G06Q 10/02; G06Q 20/18; G06Q 20/202; G06Q 20/405; G06F 17/30867; G06Q 50/01

(57) ABSTRACT

An information system that uses cloud-based components for providing services to remote kiosk users includes a first remote kiosk configured to receive a card having data indicative of a transaction request. A computer server operates in a cloud computing environment and provides processing to remote kiosk users. The system includes a computer readable memory having at least one database operating in the cloud, the memory in data communication with a processor, and the memory configured to store programming and data structures associated with customers. The card is associated with a respective customer. Programming instructions cause the processor to receive a request from the first remote kiosk to consummate a transaction, receive data from the first remote kiosk, the data provided at least by a respective card submitted at the first remote kiosk, verify the received data, consult the at least one database for transaction availability, and finalize the requested transaction.

### BACKGROUND OF THE INVENTION

This invention relates generally to information systems and, more particularly, to an information system and method of managing data cards to facilitate transactions in a cloud computing environment and in use with at least one remote kiosk.

Payment for products and services is often inconvenient in many circumstances. For instance, purchasing or re-loading value on lift tickets at a ski resort, purchasing and picking up tickets to a sporting or entertainment event, or just making purchases after waiting in line at a retail store lead to frustration, especially if different payment methods are required at each venue or circumstance. Similarly, some transactions also require a purchaser to show various forms of identification or have other personal, financial, or business credentials readily available. Needless to say, not having one or more pieces of required information available when called for can yield negative results, financial consequences, or undesired stress.

Therefore, it would be desirable to have an information system that uses specialized data cards associated with respective customers/users to facilitate cloud-computing based services in conjunction with one or more remote kiosks. Further, it would be desirable to have a method and system in which respective personal, financial, government, and social data may be stored on an RFID data card to facilitate purchases and similar transactions with use of associated kiosks. In addition, it would be desirable to have a cloud based information system that includes a social network module in which a respective data access card may be used to create a package offer to be distributed to a predetermined set of other users who may then purchase—with or without edits—using respective data access cards.

### SUMMARY OF THE INVENTION

An information system according to the present invention that uses cloud-based components for providing services to remote kiosk users includes a first remote kiosk configured to receive a card having data indicative of a transaction request. The system includes a computer server having a processor connected to a computer network operating in a cloud computing environment, the computer server providing processing services to the remote kiosk users. The system includes a computer readable memory comprising at least one database operating in the cloud computing environment, the memory in data communication with the processor, and the memory configured to store programming and data structures associated with customers. The card is associated with a respective customer. Programming instructions cause the processor to receive a request from the first remote kiosk to consummate a transaction, receive data from the first remote kiosk, the data provided at least by a respective card submitted at the first remote kiosk, wherein the card is associated with a respective card submitted at the remote kiosk, verify the received data, consult the at least one database for transaction availability, and finalize the requested transaction.

Therefore, a general object of this invention is to provide an information system having a computer server configured in a cloud computing environment that is in communication with at least one remote based kiosk that services transactions by respective customers via associated RFID data cards.

Another object of this invention is to provide an information system that facilitates the tracking of personal and business information of respective users/customers via respective RFID cards so as to enable efficient and secure transactions by users.

Still another object of this invention is to provide an information system that enables users to make transactions and purchases and then pick up resulting documentation from remote kiosks using an associated data card.

Yet another object of this invention is to provide an information system having a social networking component that enables a user to coordinate package deals that are then offered to known associates (“friends”) for optional participation and purchase.

A further object of this invention is to provide an information in which personal, financial, identification, government document data, and the like are stored on associated data cards for convenient use in associated transactions.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram illustrating an information system for making and managing purchase transactions for providing cloud-based services to members at a kiosk;

FIG. 2 is a flowchart illustrating a software routine according to the system as in FIG. 1 that enables members and vendors to enter and edit data;

FIG. 3 is a flowchart illustrating a software routine according to the system as in FIG. 1 for ordering, organizing, or joining a purchase or event;

FIG. 4 is a flowchart illustrating use of a product redemption kiosk in communication with a respective redemption kiosk according to the present invention;

FIG. 5 is a perspective view of a redemption kiosk according to the present invention; and

FIG. 6 is a flowchart of a computer-implemented method that uses cloud-based components for providing services to remote kiosk users.

### DESCRIPTION OF THE PREFERRED EMBODIMENT

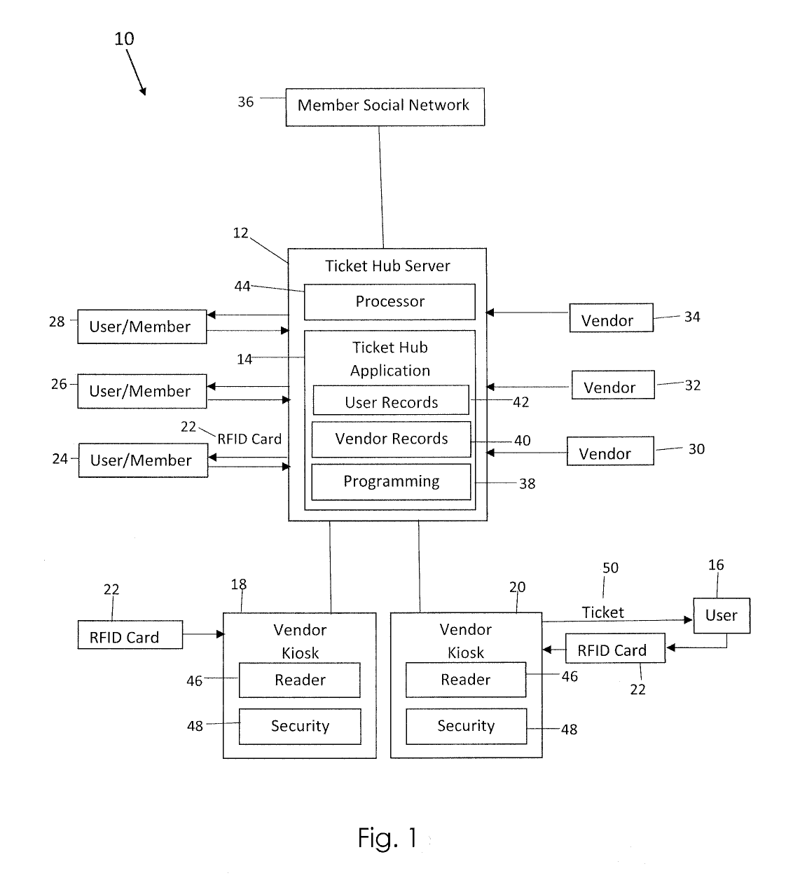

An information system and method of specialized identification card access to multiple cloud-based vendor offerings according to a preferred embodiment of the present invention is provided herein. The system and method will be described in detail with reference to FIGS. 1 to 6 of the accompanying drawings. The system 10 provides for a user 16 to carry a specialized RFID card 22 containing radio-frequency identification (RFID) functionality. The user 16 may approach any of a network of vendor kiosks 18, 20, submit the RFID card 22, and receive a variety of cloud-based services. Vendor kiosks may be situated at sporting park venues, entertainment sites, and in retail and government locations.

With the RFID card 22, the user 16 may shop for, purchase, and take delivery of documents, for example tickets, providing access to events, travel and other services. The RFID card 22 contains identifying, legal, financial, and other confidential information about the user 16. The information is transmitted using the RFID functionality embedded in the RFID card 22 to the vendor kiosk 18 to authenticate the user 16 and securely pay for tickets or other services.

The network of vendor kiosks 18, 20 communicates with at least one computer server 12 that accesses cloud-based information about events and travel made available by a network of vendors 30, 32, 34. The user 16 may wish to create a customized event that involves combining travel and event services of several vendors 30, 32, 34, for example an airline, a hotel operator in a destination city, and a ticket vendor to a sporting event at a stadium in the destination city. The server 12 provides the user 16 at a vendor kiosk 18 access via an application 14 executing on the server 12 to packages of such services provided by the vendors 30, 32, 34. The services provided in the packaged manners described herein may be more varied and financially attractive than if purchased on a one-off basis from each of the vendors 30, 32, 34 individually.

The application 14 may combine information stored in the RFID card 22, stored in the server 12, and stored in cloud-based databases of the vendors 30, 32, 34 to provide an attractive package and price for the user 16. The application 14 arranges payment by causing the kiosk 18 to read information from the RFID card 22 and transmit the information to the application 14 on the server 12. The application 14 may then verify the information from the RFID card 22 by matching the information against information stored on the server 12 and in other devices in the cloud-based system 10. When the purchase transaction is consummated, the kiosk 18 dispenses documents to the user 16, in many cases tickets and itineraries.

FIG. 1 is a block diagram illustrating the system 10 for making and managing purchase transactions. FIG. 1 provides a conceptual view of the system 10 which may be referred to as a card access system 10 (“CAS” or “CAS system”). The card access system (“CAS”) 10 includes the computer server 12, labeled in FIG. 1 as “Ticket Hub Server” that may be accessed by users 16 connected via vendor kiosks 18, 20. The CAS 10, in addition to including the server 12, also includes the application 14, labeled in FIG. 1 as “Ticket Hub Application”, the at least one user 16, the vendor kiosks 18, 20, a radio-frequency identification (RFID) card 22, user/members 24, 26, 28, vendors 30, 32, 34, and a member social network 36. Each of the server 12, the application 14 and vendor kiosks 18, 20 contains components which will be described later.

The user 16 may access vendor kiosks 18, 20 via a wide-area network from numerous locations to purchase and receive tickets and other documents to events and travel as well as access other services. Accessing the server 12 via the internet or other wide-area network may be described as doing so via “cloud computing” in that users 16 do not need to store data on the vendor kiosks 18, 20 they are using. Data of the users 16, in addition the that stored in the RFID card 22, is stored, accessed and shared by the computer server 12 from a location remote and unseen by users 16 of the services provided by the system 10.

The application 14 executes on the server 12 and provides services described herein. The application 14 includes programming 38 which is at least executable code, libraries and other electronic files stored and executing on the server 12 and elsewhere in the system 10 in some embodiments. The application 14 also includes vendor records 40 associated with vendors 30, 32, 34. The application 14 also includes user records 42 associated with the user 16 and with user/members 24, 26, 28. The application 14 executes on a processor 44 installed in the server 12. The application 14 is stored in memory (not depicted in FIG. 1) in the server 12 and in other devices in some embodiments.

The application 14 receives messages from the vendor kiosks 18, 20 which are accessed by the user 16. The user 16 may wish to plan events and access travel opportunities and other activities. The application 12 promotes the user 16 via the vendor kiosks 18, 20 to review cloud-based information provided by vendors 30, 32, 34 about such events and travel opportunities.

Using the RFID card 22 at vendor kiosk 18 or vendor kiosk 20, the user 16 accesses the application 14 executing on the server 12. The RFID card 22 contains information about the user including identification information, driver license information, insurance information, and banking and credit card information. In an embodiment the RFID card 22 may also include the social security number of the user 16, other identifying information, and hints about personal identification numbers (PINs) of the user 16. The RFID card 22 may also include information about purchasing preferences and previous purchase history of the user 16. When the user 16 approaches one of vendor kiosks 18, 20, the user 16 may be asked to produce his RFID card 22 and submit it for reading or scanning. A reader 46 executing on the vendor kiosk 18, 20 approached by the user 16 will be activated by and read the RFID card 22. A security module 48 also executing on the vendor kiosk 18, 20 will be engaged and authenticate the RFID card 22 using methods known at least to RFID technology. In an embodiment, the security module 48 or other component may request the user 16 to enter a password or other credential to supplement security procedures associated with reading the RFID card 22. Other security elements may also be employed, such as fingerprint, retinal scan, and biometric data entry.

The vendor kiosks 18, 20 are machines situated at venues for sporting, cultural and other events and accessible to the user 16. The vendor kiosks 18, 20 may also be located at venues associated with travel, for example at airports, at airline ticket offices, and at travel agencies and bureaus. Further, the vendor kiosks 18, 20 may also be situated at sites or properties of particular vendors 30, 32, 34. The vendor kiosks 18, 20 may alternatively be situated at locations not affiliated with any particular venue, event or vendor 30, 32, 34. The vendor kiosks 18, 20 may be outfitted with keyboards, screens, and document dispensing apparatus as well as reader 46 and security module 48.

The dispensing apparatus (not depicted in FIG. 1) of the vendor kiosks 18, 20 dispenses tickets 50 to the user 16. In an embodiment and as depicted in association with vendor kiosk 20 in FIG. 1, the user may provide the RFID card 22 and a previously purchased ticket 50 back to the vendor kiosk 20 with a request to reload the ticket 50 with further value. In an example of such an embodiment, the user 16 is a skier at a winter resort and initially purchased a ticket 50 using the vendor kiosk 20 for Saturday and Sunday skiing. The user 16 then decides to stay an extra day to ski on Monday. The user 16 accesses the vendor kiosk 20, provides his/her RFID card 22 and the previously purchased ticket 50. The vendor kiosk 20 and the application 14 remotely executing on the server 12 work together to process the sale of another day of resort access for the user 16. The ticket 50 is loaded with the additional day's value and a bank account, credit card account, or another account stored on the RFID card 22 is charged. The ski resort operator, depicted in FIG. 1 as vendor 30, may have accessed its vendor records 40 during the transaction to examine the purchase history and other information about the user 16 and perhaps provide customized offers for dining, lodging, shopping and entertainment for the additional day's stay as well as for future visits by the user 16 at the resort.

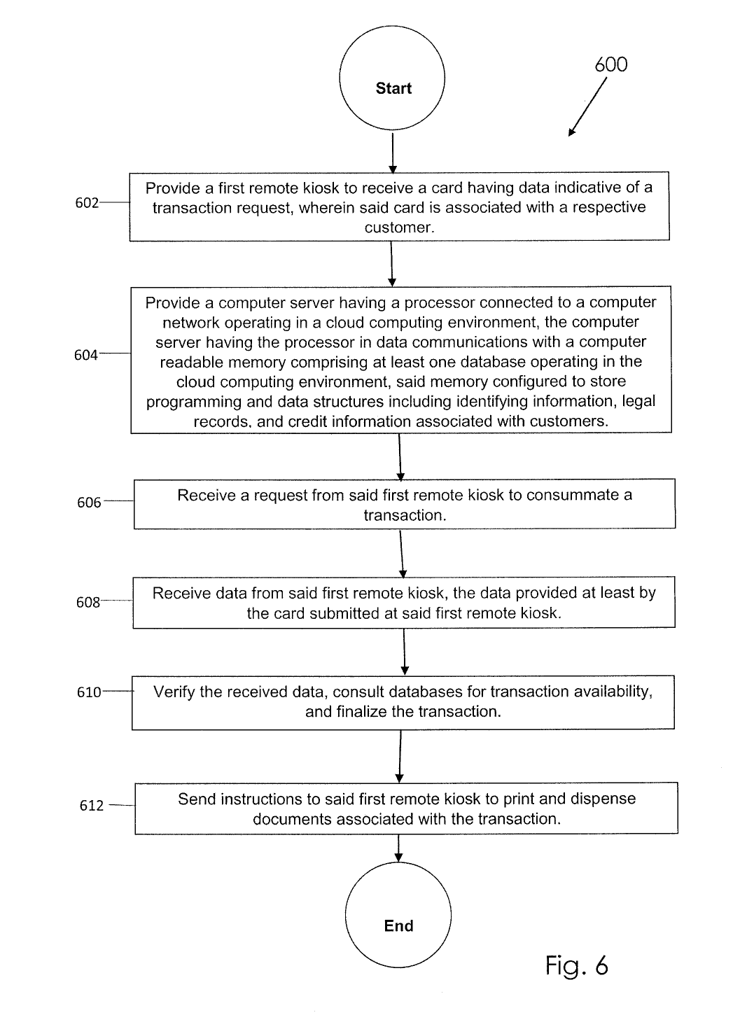

Turning to FIG. 6, a method 600 is provided. The method 600 includes steps carried out using the components of system 10 connected to a cloud computing environment. The method 600 is executed by programming 38 and data structures stored in computer readable memory in data communication with the processor 44. The data structures include identifying information associated with a user 16, legal records associated with the user 16, and credit information associated with the user 16. The programming, when executed by the processor 44, causes the processor 44 to execute method steps 602 through 612 depicted in FIG. 6.

The method 600 begins at block 602, in which a first remote kiosk is provided, the first remote kiosk configured to receive a card having data indicative of a transaction request, wherein said card is associated with a respective customer. At block 604, a computer server is provided, the computer server having a processor connected to a computer network operating in a cloud computing environment, the computer server having the processor in data communication with a computer readable memory comprising at least one database operating in the cloud computing environment, said memory configured to store programming and data structures including identifying information, legal records, and credit information associated with customers.

At block 606, the computer server receives a request from the first remote kiosk to consummate a transaction. At block 608, the computer server receives data from said first remote kiosk, the data provided at least by said card submitted at said first remote kiosk. At block 610, the computer server verifies said received data, consults said at least one database for transaction availability, and finalizes said transaction. At block 612, the computer server sends instructions to said first remote kiosk to print and dispense documents associated with said transaction. The method 600 terminates thereafter.

Transaction availability refers to tickets 50 or other item(s) requested for purchase by the user 16 being available at the price and terms the user 16 requested. Transaction availability also refers to the packaged event still being available at all, for example that the event did not become sold out in the time since the user 16 first entered his/her request. Finalizing a transaction refers to booking and completing the sale, including charging an account of the user 16.

The RFID card 22 is provided by the user 16 of the kiosk 18 to facilitate the transaction. The RFID card 22 uses radio-frequency identification (RFID) to store and transmit the data. The RFID card 22 contains further identifying information, driver license information, insurance coverage information, and bank account information regarding the user 16. The transaction results in a purchase of goods comprising tickets 50 to at least one of events and travel.

A plurality of kiosks 18, 20 are situated at event venues and venues associated with travel. A network of cloud-based databases containing records associated with a plurality of vendors 30, 32, 34 is accessed by the computer server 12.

The kiosk 18 dispenses documents at the direction of the computer server 12 for transactions one of previously paid for and transactions paid for at the time of dispensing of the documents. An interface provided at least by the application 14 and displayed at the remote kiosks 18, 20 promotes users 16 to create packaged events by accessing and combining special offers described in the network of cloud-based databases.

Packaged events are published to at least one social networking venue for review and purchase by invitees designated by users 16. The at least one social networking venue is provided by the system 10 as a member social network 36.

Invitees may purchase a packaged event described in the packaged event data as published, purchase the packaged event in a format modified in accordance with their preferences, and may decline to purchase the packaged event entirely. When the invitee purchases the packaged event in modified format, the invitee may select a first portion of the packaged event and not select a second portion of the packaged event and may add a third portion to the packaged event.

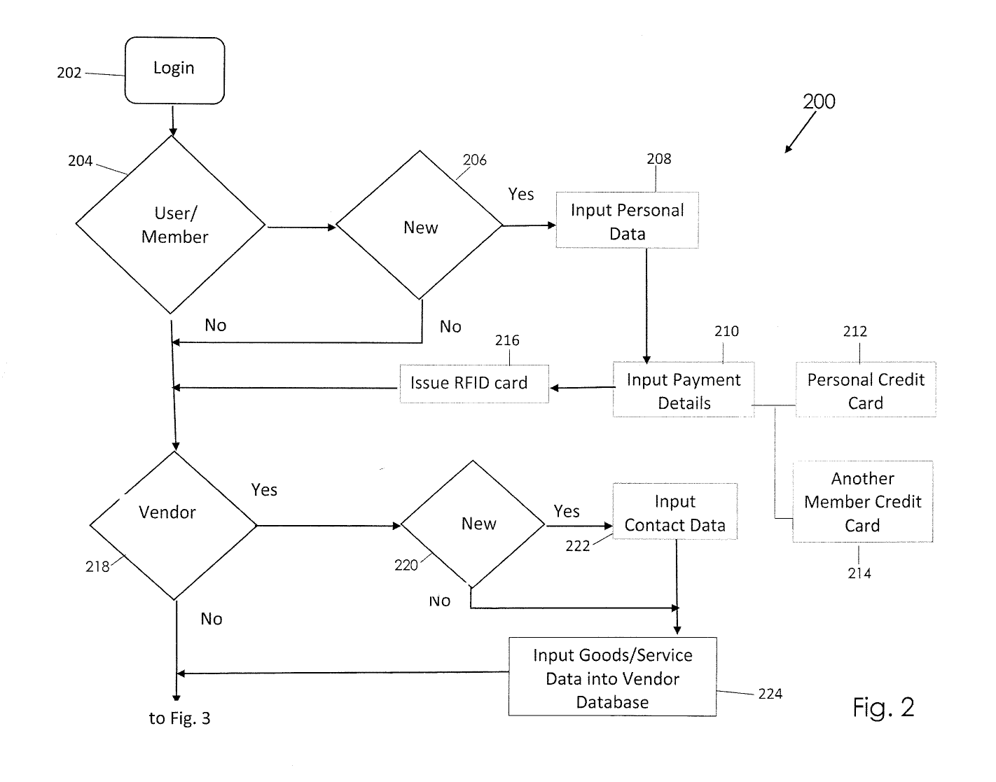

Turning to FIG. 2, a flowchart illustrating a software routine or method 200 according to the system as in FIG. 1 that enables members and vendors to enter and enter data is provided. It is understood that the interactions and method steps described below are by the processor in the server executing respective programming instructions. The flowchart illustrates initial interactions of the user 16 with the system 10. Beginning at block 202, the user 16 logs in. At decision point 204, the application 14 executing on the server 12 asks whether the user 16 is a member. If yes, the interaction proceeds to decision point 206 whereupon the application 14 asks whether the user 16 is a new member. If yes, at block 208, personal data of the user 16 is input and at block 210 payment details are input. Such payment details may include a personal credit card 212 or another member credit card 214. At block 216 the RFID card 22 is issued and the interaction continues to decision point 218. If at decision point 206 the user is determined to be not a new member the interaction proceeds directly to decision point 218.

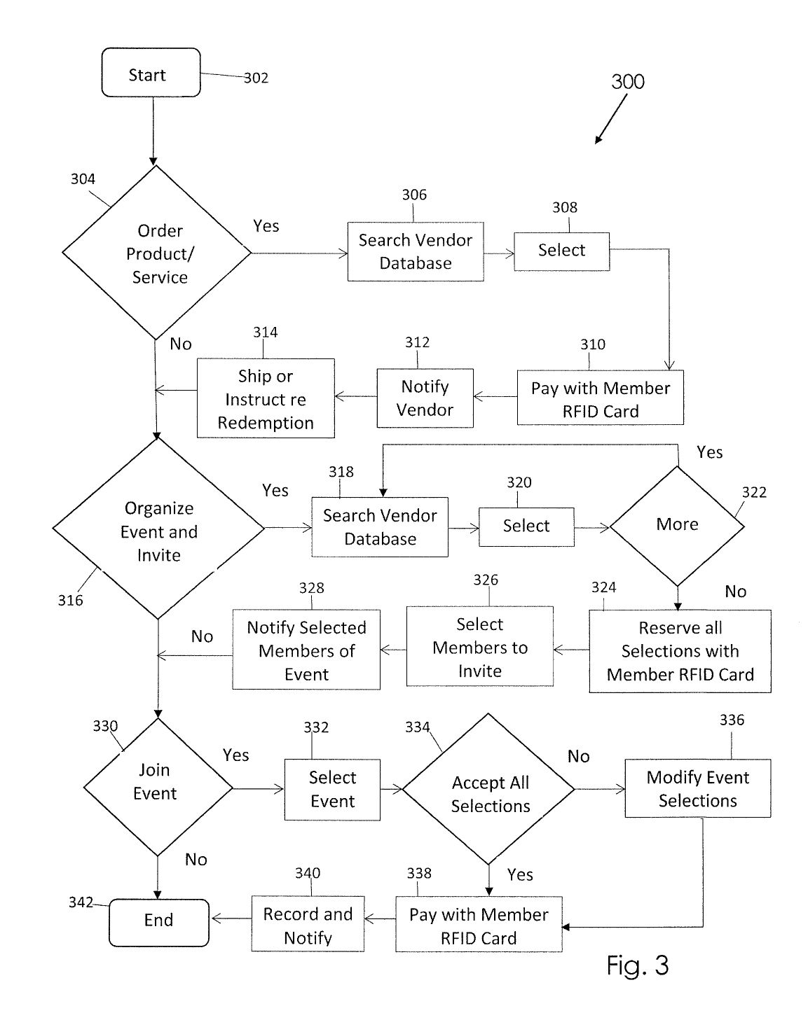

At decision point 218, the application 14 asks whether the party that logged in is a vendor. If yes, the interaction asks at decision point 220 whether the vendor is new. If yes, contact data is input at block 222. At block 224, goods and services data is entered into a vendor database and the interaction exits to the process depicted in FIG. 3. If at decision point 220 the vendor is determined to be not new, the process bypasses input of contact data and proceeds directly to input of goods and services data into a vendor database at block 224. The interaction then exits to the process depicted in FIG. 3. If at decision point 218 it is determined that the party logged in is not a vendor, the interaction exits to the process depicted in FIG. 3.

Turning to FIG. 3, a flowchart illustrating a software process or method 300 according the system as in FIG. 1 for ordering, organizing or joining an event is provided. An embodiment including a social networking component is also discussed. User/members 24, 26, 28 can put together an event or package, possibly from “deals” provided by vendors 30, 32, 36. The application 14 will publish a particular event or package to contacts of the user/member 24 in the member social network 36 as invitees. The invitees may edit or select parts of the event or package that they wish to participate in and make payment if applicable.

The process 300 of FIG. 3 starts at block 302 and proceeds to decision point 304 where the application 14 asks if the user/member 24 wishes to order a product or service. If yes, the interaction proceeds to searching vendor database at block 306 and accepting selections from the user/member 24 at block 308. The user/member 24 then pays with his or her RFID card 22 at block 310. At block 312 the vendor is notified. At block 314 actions associated with shipping or instructing regarding redemption are taken and the interaction proceeds to decision point 316. If at decision point 304 where the application 14 asked if the user/member 24 wishes to order a product or service and the answer was no, the interaction would then proceed directly to decision point 316.

At decision point 316, the user/member 24 is asked whether he or she wishes to organize an event and send invitations. If yes, the vendor database is searched by the user/member 24 at block 318 and selections are made at block 320. The interaction proceeds to decision point 322 where the user/member 24 is asked if more searching and selections are to be made. If yes, the interaction loops back to blocks 318 and 320 for further searching of the vendor database and selections, respectively, with the loop continuing until the user/member 24 is finished and the interaction exits decision point 322.

The process 300 of FIG. 3 continues to block 324 where all selections made at block 320 are reserved with the RFID card 22. At block 326, the user/member 24 selects members to invite. Invitations may be provided via the member social network 36. At block 328 the process notifies selected members of the event and the interaction proceeds to decision point 330. If earlier at decision point 316 the user/member 24 responded negatively to the question of whether he or she wishes to organize an event and send out invitations, the interaction would have proceeded directly to decision point 330.

At decision point 330, an invitee is asked whether he or she wishes to joint an event. If yes, at block 332 an event is selected and at decision point 334 the invitee is asked if all selections are accepted. If yes, at block 338 payment is made with member RFID card 22, record and notify takes place at block 340 and the interaction ends at block 342. If at decision point 334, when the invitee is asked if all selections are accepted and the invitee responds negatively, the interaction proceeds to block 336 where event selections are modified. The interaction proceeds to block 338 where payment is made with member RFID card 22. Actions for record and notify then take place at block 340 and the interaction ends at block 342.

The invitee described in FIG. 3 is given the opportunity to select all, some, or none of the options made part of the package created by the user/member 24. By placing the package on the member social network 36, the user/member 24 can invite a group of friends and provide information about the package and its component parts.

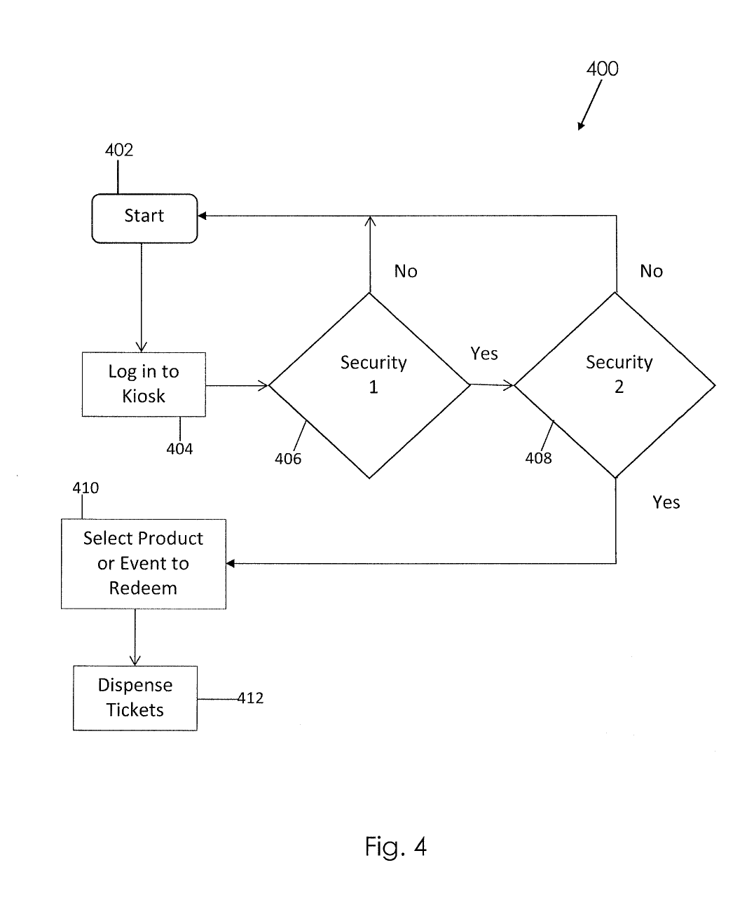

Turning to FIG. 4, a flowchart illustrating a process 400 of using of a product redemption kiosk according to the present invention is provided. The process 400 of FIG. 4 begins at block 402. At block 404 the user 16 logs into a vendor kiosk 18, 20. Proceeding to decision point 406, a first security test is performed, entitled “Security 1”. If the user 16 fails this test, the user 16 is cycled back to the beginning of the interaction at block 402. If the user 16 passes the test at decision point 406, the user 16 then proceeds to decision point 408 where a second security test, entitled “Security 2” is performed. If the user fails this test, the user 16 is cycled back to the beginning of the process 400 at block 402. If the user 16 passes the security test at block 408, the user 16 then proceeds to block 410 where the user 16 selects product or event to redeem. The user 16 thereafter proceeds to block 412 where the action taken is dispense tickets.

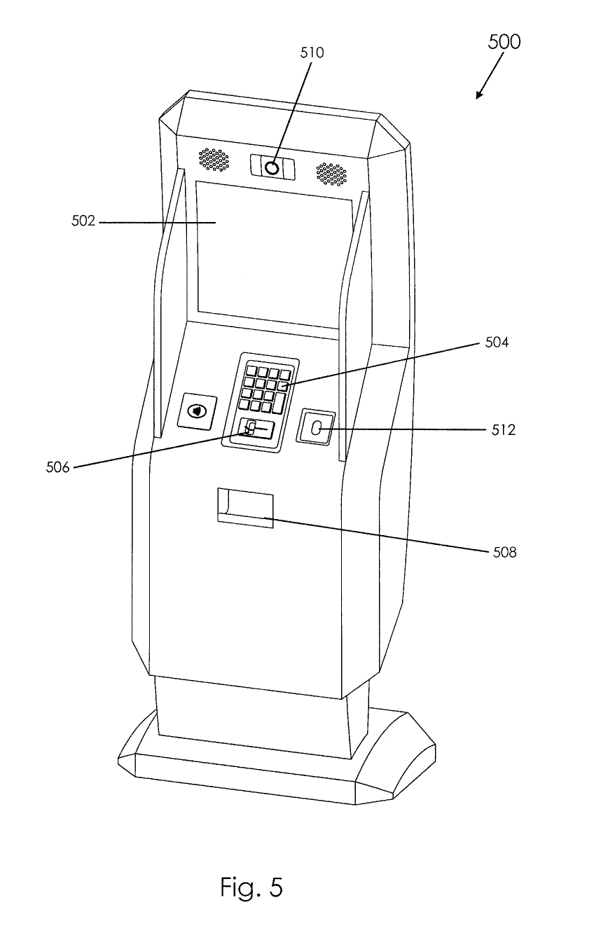

Turning to FIG. 5, a perspective view of a redemption kiosk according to the present invention is provided. FIG. 5 depicts a kiosk 500 that may represent an embodiment of vendor kiosks 18, 20 provided by system 10. Kiosk 500 includes a viewing monitor 502, a keypad 504, and a card slot or reader 506 for a user 16 to enter a card such as the RFID card 22 provided by system 10. Kiosk 500 also includes a dispensing mechanism 508 below the keypad 504 where documents, for example tickets 50 provided by system 10 may be dispensed. At the top of the kiosk 500 is a camera lens 510 for photographing or filming the user 16. To the right of the keypad 504 is a touch pad 512 for the user 16 to provide a thumbprint or other biometric entry.

In an embodiment, the system 10 allows the user 16 to take delivery of documents for transactions wherein payment has been made previously or is made at the time that documents are dispensed. A user 16 may in an embodiment be a child or a legal minor and use the RFID card 22 with parental approval. Vendors 30, 32, 34 may become vendor members and may input their own data into the system 10, for example ticket offerings, hotel offerings, and package promotions.

It is understood that while certain forms of this invention have been illustrated and described, it is not limited thereto except insofar as such limitations are included in the following claims and allowable functional equivalents thereof.

What is claimed is:

1. An information system that uses cloud-based components for providing services to remote kiosk users, comprising:
a first remote kiosk configured to receive a card having data indicative of a transaction request;
a computer server having a processor connected to a computer network operating in a cloud computing environment, the computer server providing processing services to the remote kiosk users; and
a computer readable memory comprising at least one database operating in the cloud computing environment, said memory in data communication with said processor, and said memory configured to store programming and data structures associated with customers;
wherein said card is associated with a respective customer;
wherein said data structures include identifying information, legal records, and credit information associated with respective customers; and
wherein said programming, when executed by said processor, causes said processor to:
receive a request from said first remote kiosk to consummate a transaction;
receive data from said first remote kiosk, the data provided at least by a respective card submitted at said first remote kiosk;
verify the received data, consult the at least one database for transaction availability, and finalize the requested transaction; and
send instructions to said first remote kiosk to print and dispense documents associated with the requested transaction.

2. The system as in claim 1, wherein said respective card is provided by said respective customer at said first remote kiosk to facilitate the requested transaction.

3. The system as in claim 1, wherein said card uses radio-frequency identification (RFID) to store and transmit the data.

4. The system as in claim 1, wherein said card contains further identifying information, driver license information, insurance coverage information, and bank account information regarding the customer.

5. The system as in claim 1, wherein the requested transaction results in a purchase of goods including tickets to at least one of events and travel.

6. The system as in claim 1, wherein a plurality of remote kiosks are situated at event venues and venues associated with travel.

7. The system as in claim 1, wherein the at least one database contains records associated with a plurality of vendors and is accessed by the computer server.

8. The system as in claim 1, wherein said first remote kiosk is configured to dispense documents at the direction of said computer server for one of transactions previously paid for and transactions paid for at the time of dispensing of documents.

9. The system as in claim 7, further comprising an interface configured to receive packaged event data from said respective customer, said packaged event data being selected from special offers published by said plurality of vendors in said at least one database.

10. The system as in claim 9, wherein the packaged event data is published to at least one social networking venue for review and purchase by invitees designated by said respective customer.

11. The system as in claim 10, wherein the interface is further configured to receive responses from said invitees entered via said social networking venue, said responses comprising invitees at least one of purchasing a packaged event as published, purchasing said packaged event in a format modified in accordance with preferences of at least one invitee, and declining to purchase said packaged event entirely.

12. The system as in claim 11, wherein the interface is further configured to receive an at least one invitee response purchasing said packaged event in the modified format comprising an at least one invitee at least one of selecting a first portion of said packaged event and not selecting a second portion of said package event and adding a third portion to said packaged event.

13. A computer-implemented method that uses cloud-based components for providing services to remote kiosk users, said method comprising:
providing a first remote kiosk to receive a card having data indicative of a transaction request, wherein said card is associated with a respective customer;
providing a computer server having a processor connected to a computer network operating in a cloud computing environment, said computer server having the processor in data communication with a computer readable memory comprising at least one database operating in the cloud computing environment, said memory configured to store programming and data structures including identifying information, legal records, and credit information associated with customers;
receiving a request from said first remote kiosk to consummate a transaction;
receiving data from said first remote kiosk, the data provided at least by said card submitted at said first remote kiosk;
verifying said received data, consulting said at least one database for transaction availability, and finalizing said transaction; and
sending instructions to said first remote kiosk to print and dispense documents associated with said transaction.

14. The computer-implemented method as in claim 13, wherein said card uses radio-frequency identification (RFID) to store and transmit the data.

15. The computer-implemented method as in claim 13, wherein said transaction results in a purchase of goods that includes tickets to at least one of events and travel.

16. The computer-implemented method as in claim 13, wherein said at least one database contains records associated with a plurality of vendors and is accessible by said computer server.

17. The computer-implemented method as in claim 16, further comprising an interface configured to receive packaged event data from said respective customer, said packaged event data being selected from special offers published by said plurality of vendors in said at least one database.

18. The computer-implemented method as in claim 17, wherein said packaged event data is published to at least one social networking venue for review and purchase by invitees designated by said respective customer.

19. The system as in claim 18, further comprising a step that at least one designated invitee one of purchases a packaged event described in said packaged event data as published, purchases said packaged event in a format modified in accordance with preferences of said at least one designated invitee, and declines to purchase said packaged event entirely.

20. The system as in claim 19, wherein said at least one invitee purchasing said packaged event in said modified format comprises said at least one invitee at least one of selecting a first portion of said packaged event and not selecting a second portion of said package event and adding a third portion to said packaged event.
